(19) United States
(12) Patent Application Publication
(10) Pub. No.: US 2019/0091818 A1
(43) Pub. Date: Mar. 28, 2019

(54) APPARATUS WITH EXTRACTION DEVICE

(71) Applicant: HOMAG GmbH, Schopfloch (DE)

(72) Inventor: Stephen WINNEY, Freudenstadt (DE)

(73) Assignee: HOMAG GmbH, Schopfloch (DE)

(21) Appl. No.: 16/080,985

(22) PCT Filed: Mar. 3, 2017
(86) PCT No.: PCT/EP2017/055035

§ 371 Date: Aug. 29, 2018

(30) Foreign Application Priority Data
Mar. 4, 2016 (DE) 10 2016 203 578.9

(51) Int. Cl. B23Q 11/00; B23D 59/00

(52) U.S. Cl. CPC B23Q 11/0046; B23D 59/006

(57) ABSTRACT

The present invention concerns an apparatus for machining workpieces (W), comprising: a machining device (30) for machining the workpieces (W), an extraction device (40) for extracting chips produced during machining.

### TECHNICAL FIELD

The present invention concerns an apparatus for machining workpieces with an extraction device. Such an apparatus is used in particular to manufacture workpieces or components for the furniture and component industries.

### Prior Art

The state of the art is e.g. DE 197 27 361 A1, in which a conveying device with variable transport speed, with a number of parallel transport belts, drive and deflection rollers for receiving the transport belts and at least one motor for driving at least one of the rollers, is described. The conveying device described is particularly characterized in that it has a suction box with a cover plate in which the transport belts are guided in grooves such that the transport belts project slightly above the cover plate so that they form a conveying surface for the material to be conveyed. Furthermore, the suction box has suction openings through which the material to be conveyed can be sucked in, thus increasing the contact pressure of the material to be conveyed on the conveyor belts. Due to the increased contact pressure between the transport belt and the material to be conveyed, a frictional connection between the material to be conveyed and the transport belt can be established, whereby the material to be conveyed can be reliably transported at an exact transport speed. The increased contact pressure also makes it possible to transport the material to be conveyed on conveyors with inclines or slopes.

Subject Matter of the Invention

An object of the present invention is to provide a machining apparatus and method which ensure safe machining of workpieces and simultaneous extraction of chips or the like produced during machining.

This object is achieved by an apparatus for machining workpieces according to claim 1 and a method for machining according to claim 15.

One of the core ideas of the present invention is to provide an apparatus for machining workpieces, in which the chips produced during machining are extracted promptly using an extraction device, and furthermore the workpieces to be machined are sucked in at a defined suction area, wherein the extraction device and the suction area can be supplied with vacuum via a common vacuum device.

The device described in claim 1 comprises a vacuum interface area, in particular a connection portion, for a vacuum device, which vacuum interface area is in particular fluidically connected to the extraction device and the suction area to supply the extraction area and the suction area with vacuum.

The extraction device and the suction area can thus be fluidically connected with or brought into contact with a vacuum device. In this respect, the apparatus according to the invention may include the vacuum device. Alternatively, the vacuum device can be provided separately from the apparatus according to the invention.

In particular, in an embodiment, the vacuum device may be integrated in the apparatus (for example within a housing of the apparatus). In this case, the vacuum interface area is located within the apparatus, for example as a connection portion within the apparatus, or is formed by an outlet or an opening of the vacuum device. This provides a particularly compact design.

According to another embodiment, the vacuum device can be mounted outside the apparatus (for example on a housing of the apparatus). Thus, the vacuum device is advantageously accessible for maintenance work.

Alternatively, the vacuum device can be provided separately from the apparatus according to the invention. For example, it is a vacuum device arranged near the apparatus according to the invention or a vacuum supply system which can be used by several apparatus. In this case, the vacuum interface area is provided, for example, as a connection portion on the apparatus housing. A separate vacuum device has the advantage that the apparatus according to the invention can be moved separately from it.

In a further embodiment, several vacuum units can form the vacuum device in order to jointly generate a vacuum.

By means of the proposed apparatus, the workpieces to be machined can be safely held or guided during machining, which guarantees dimensionally accurate machining and also facilitates the machining process. In addition, waste such as chips/dust can be extracted immediately by means of the extraction device provided, which prevents soiling of the working area, in particular of the extraction area.

In accordance with a preferred embodiment of the present invention, the apparatus also has a conveying device with a conveying path with which the workpieces can be transported, in particular horizontally, and which is provided with at least one transport device. Furthermore, the machining device can be arranged in the area of the conveying path and the workpieces are sucked in, by means of the suction area, in the direction of the at least one transport device.

In this way, the contact pressure of the workpieces to be machined on the transport device can be increased, whereby a frictional connection can be established between the transport device and the individual workpiece, whereby the workpiece can be transported at an exact transport speed and high positional accuracy, since no slippage occurs between the transport device and the workpiece. Furthermore, the device according to the invention can prevent that the chips produced during machining contaminate the conveying device and in particular the intended suction area, and thus possibly impair the functionality of the conveyor and the suction area. In addition, if the workpiece is sucked sufficiently strongly onto the transport device, and thus sufficient frictional connection between transport device and workpiece is created, an additional feed device, which exerts a feed force on the workpiece during machining, can be dispensed with. This means that the necessary feed force for machining can be provided by the conveying device, which simplifies the construction of the apparatus for machining workpieces according to the present invention.

The machining tool has a machining direction parallel to the conveying direction. The workpieces to be machined are preferably plate-shaped workpieces, especially raw boards, which consist at least partly of wood, engineered wood, plastic, aluminum or a combination thereof

If the extraction device and the suction area are supplied with vacuum using a common vacuum device, as suggested as preferable, the effort with regard to the provision of flow channels can be reduced. Furthermore, only one vacuum device is required, which reduces the effort and thus the costs for the manufacture of the apparatus as well as the operating costs.

In particular, according to a preferred embodiment, a separate vacuum device or vacuum pump provided in the machining device for providing the required vacuum can be dispensed with and instead a central chip extraction system (provided in many woodworking operations) can be used. This also reduces the manufacturing costs and the operating costs of the machining apparatus. Furthermore, the use of an external, preferably central extraction system makes it unnecessary to integrate a dust filter or collection container for chips. This prevents possible disturbances of a vacuum device integrated in the device due to contamination. If this is not possible or not possible on site, the vacuum device may also be integrated into the apparatus for machining; this can be particularly advantageous if the apparatus is not stationary.

According to an embodiment, the extraction device has an extraction chamber which partially surrounds the tool of the machining device and is arranged below the conveying path, whereby the chips are extracted downwards as seen from the conveying path. In this case, the extraction chamber preferably reaches almost to a conveying plane which is formed by the transport device and extends parallel to the transport device. This eliminates the extraction hood provided by conventional parting machines, usually located above the machining device, which improves the accessibility of the machining device and the conveying path. Furthermore, the effort for the necessary tubing/piping or the provision of flow channels can be further reduced, as the air flow guiding elements for the extraction device and the extraction area below the conveying path can be jointly provided. Furthermore, the extraction power of the extraction device can be improved, and in particular the extraction can be concentrated on the area or areas where the chips mainly occur, i.e. in the immediate vicinity of the tool.

According to a further development of the present invention, the conveying device has at least two transport devices running parallel to each other, which are each received by means of a drive roller and a deflection roller, and are driven by at least one motor. In addition, the tool shall be provided between the at least two transport devices, in particular in the centre of the at least two transport devices. The at least two transport devices and the central arrangement of the tool ensure that the workpiece does not rotate during machining, because of the action, on both sides of the tool, of feed forces (F_{VL}, F_{VR}) resulting from the frictional connection between transport device and workpiece; the two feed forces (F_{VL}, F_{VR}) being largely equal.

Furthermore, the suction area can be arranged between the at least two transport devices of the conveying device and the tool and have a large number of suction holes which are used for the suction of the workpieces. Preferably, the suction area is provided near the workpiece, whereby a maximum contact pressure of the workpiece on the transport device near the workpiece can be realized, whereby a maximum frictional connection between the workpiece to be machined and the transport device(s) is present during the machining process, whereby a sufficient feed force for the machining process can be ensured. Furthermore, this ensures sufficient positioning accuracy of the workpiece for machining. For this purpose, the number of suction holes (density of the intended suction holes) can be varied, in particular increased near the tool and reduced in marginal areas.

Due to the close arrangement of the suction area to the machining point, the load or soiling of the suction area with chips and dust is extremely high, which is why the common provision of the extraction device and the suction area, especially the common supply of the extraction device and the suction area with vacuum according to the invention, is particularly advantageous.

According to an embodiment, the extraction device and suction area are connected, flow-wise parallel to each other, to the vacuum device, in particular via a common extraction connection, wherein the suction area is preferably divided into a feed-in suction area and a feed-out suction area. With this embodiment, it is possible to adjust the suction power of the extraction device and the suction area or areas independently of one another. This makes it possible to adapt the apparatus for machining to product-specific factors such as weight, surface finish and chip development.

Furthermore, the conveying device can feature at least four parallel transport devices, whereby the frictional connection between the workpiece and the transport devices can be further increased. As a result of the greater distance between tool and transport devices, especially the greater distance between the tool and the respective external transport devices, the lever between the resulting feed force and cutting force of the tool can be increased, which leads to a more stable machining process and a more stable transport of the workpiece, especially during machining. Furthermore, this ensures the straight onward transport of the machined workpiece.

According to a further development, the apparatus for machining also comprises a hold-down device with several rollers, belts, rails and the like arranged consecutively in the conveying direction for hold-down or additional pressing of the workpieces against the transport device(s). In this way, the workpieces can be pressed onto the transport device(s) in addition to the contact pressure achieved by the suction, if necessary, thus ensuring sufficient frictional connection between transport device(s) and workpiece; this can be particularly necessary if the cutting force during machining is extremely high, for example with thicker workpieces or harder materials such as e.g. aluminum.

Furthermore, the transport device(s) can be designed as a chain or toothed belt, in particular a toothed belt which consists of natural rubber, silicone rubber or a corresponding material with a high coefficient of friction in the area of contact with the workpieces. This makes it possible to increase the friction between the workpiece and the transport device(s), which means that the necessary frictional connection between the workpiece and the transport device(s) can be achieved more easily. As a result, the necessary suction power of the suction area or areas can be reduced if necessary, thus saving energy.

Preferably, the machining device can be designed as a cutting device provided with a saw blade. In this way, the chips produced during the sawing process can be extracted by the extraction device and, if necessary, fed to a central extraction system. Furthermore, the workpiece to be cut can be sufficiently pressed against the transport device(s) simultaneously by the suction area(s), so that sufficient feed force for the sawing process is only available due to the transport movement by the conveying device. In this case, in combination with the at least four transport devices and the central arrangement of the tool, it can also be ensured that the two workpiece halves resulting from the cutting process are transported away cleanly, i.e. without twisting.

According to an embodiment, the apparatus for machining plate-shaped workpieces further comprises a base frame for receiving the conveying device, the machining device, the extraction device and the suction area or areas, which base frame is formed below the conveying device in the form of a box housing which has a feed-in bulkhead wall, a feed-out bulkhead wall and a rear bulkhead wall. Here the bulkhead walls serve for the defined formation of extraction chambers. More precisely, the feed-in bulkhead wall together with a cover plate of the extraction chamber and outer walls of the box housing forms a feed-in extraction chamber located below the feed-in suction area. The feed-out bulkhead wall together with the cover plate of the extraction chamber, the rear bulkhead wall and the outer walls of the box housing form a feed-out extraction chamber, which is arranged below the feed-out suction area. Furthermore, the extraction chamber is preferably designed open downwards, into the box housing, whereby three openly communicating extraction chambers are formed, which are preferably connected to the vacuum device parallel to each other by means of the common extraction connection, which is provided e.g. on an outer wall of the box housing.

This makes it easy to establish a fluid connection between the suction area or areas, extraction device (extraction chamber) and vacuum device without the need for large tubing or piping. In particular, the design of the bulkhead walls can influence the flow behaviour of the suction air, whereby the suction power (extraction power or suction power) in the three extraction chambers can be varied or adjusted.

Furthermore, the extraction connection can be circular, wherein the extraction connection preferably has a diameter of 200 mm. The extraction connection can be provided especially in the lower area of an outer wall of the box housing, whereby the individual extraction chambers can be supplied evenly (without turbulences) with suction air (vacuum). In this way it is also possible to avoid a large accumulation of chips in the box housing.

According to a further development, it is also possible to accommodate the feed-in bulkhead wall and the feed-out bulkhead wall in the box housing such that they can each be pivoted about an axis in such a way that the orientation of the two bulkhead walls relative to one another can be varied, whereby the suction air ratio between the three extraction chambers can be varied. This makes it possible to vary the suction air ratio and the associated suction power of the three extraction chambers using a simple design solution, enabling adaptation to product-specific factors such as weight, surface finish and chip development.

Furthermore, the suction area or areas can be formed by cover plates of the box housing, which have the plurality of suction holes. In this way, it is possible to form the suction area or areas in a simple manner. Furthermore, it is easy to change the suction characteristics (suction capacity and distribution or number of suction holes), as it is only necessary to replace the cover plates. This also enables quick and easy maintenance of the apparatus.

According to a further development, the suction area or areas are preferably realized as closed suction box or boxes, which are especially designed as suction pipe(s). This way, it is possible to form the suction area(s) as a closed unit or units that can be easily replaced. This offers the advantage, especially with regard to air tightness, that the box housing itself does not have to be airtight or almost airtight, but it is sufficient if the suction box or boxes and the extraction chamber, which is arranged inside the box housing, are sufficiently airtight. This is a simple way to avoid unwanted noise caused by air flowing through holes and/or gaps in the box housing.

Furthermore, the invention concerns a method which can preferably use one of the aforementioned aspects.

### BRIEF DESCRIPTION OF THE DRAWINGS

FIG. 1 shows a cross-sectional front view of an embodiment of the apparatus for machining workpieces according to the present invention,

FIG. 2 shows a plan view of an embodiment of the apparatus for machining workpieces according to the present invention with two transport devices, the two suction areas being formed by means of cover plates,

FIG. 3 shows a plan view of an embodiment of the apparatus for machining workpieces according to the present invention with four transport devices, the suction areas being formed by means of cover plates,

FIG. 4 shows a plan view of an embodiment of the apparatus for machining workpieces according to the present invention with four transport devices, the suction areas being formed by means of closed suction boxes, and

FIG. 5 shows a plan view of an embodiment of the apparatus for machining workpieces according to the present invention with two transport devices, a workpiece to be machined being shown.

### DETAILED DESCRIPTION OF PREFERRED EMBODIMENTS

In the following, preferred embodiments of the present invention are described with reference to the attached figures. Further variants and modifications of individual features mentioned in this context can be combined with each other to form new embodiments.

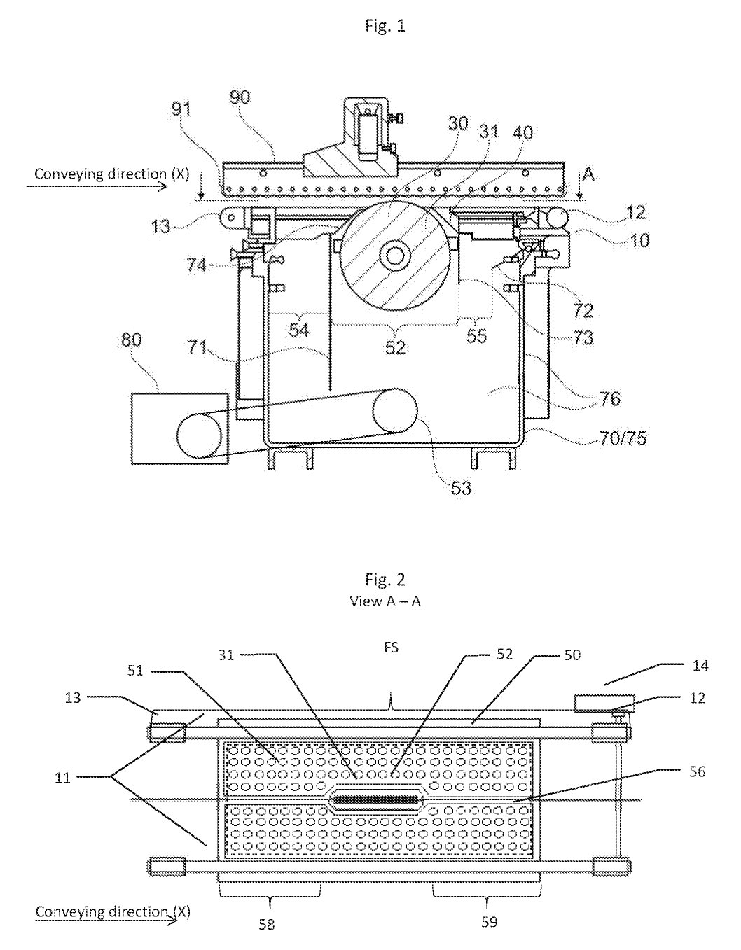

FIG. 1 shows a cross-sectional front view of an apparatus for machining plate-shaped workpieces W according to a preferred embodiment of the present invention. Within the apparatus shown, the plate-shaped workpieces W can be conveyed in a horizontal direction using a conveying device 10, so that the workpieces W are guided past a machining device 30 (in FIG. 1, for example, from left to right). The machining device 30 is arranged in particular in the area of a conveying path FS of the conveying device 10 and carries out machining on the conveyed workpieces W with a tool 31. Furthermore, as shown in FIG. 1, the apparatus has an extraction device 40 with which the chips produced by the machining device 30 during machining of the workpieces W are sucked out and removed. As illustrated in FIG. 1, the device also has a vacuum device 80 which serves to supply extraction device 40 and suction area 50 (see FIG. 2-5) with sufficient vacuum.

Here the vacuum device 80 can be formed externally, i.e. separately from the apparatus for machining, or integrated in the apparatus. The external variant is particularly suitable if a central extraction system is installed on the installation site of the device, for example in a preparation area of a wood processing plant. In this case, special maintenance of the apparatus, i.e. the maintenance and cleaning of dust filters, the emptying of collecting containers for the chips, etc. can be left out.

However, to simplify the illustration, FIG. 1 shows an example of a variant in which the vacuum device is integrated in the apparatus or designed as a separate vacuum device but part of the apparatus in close proximity. This offers a particular advantage if the apparatus for machining is not installed in a fixed location but is a mobile device. This eliminates the need to connect or disconnect from the central extraction system. The vacuum device is preferably provided in the form of a vacuum pump.

The extraction device 40 also has an extraction chamber 52, which, as shown in FIG. 2, partly surrounds tool 31 and which is arranged below the conveying path FS. The extraction chamber 52 is open towards the top and fluidically connected with the vacuum device on the underside of the conveying path FS, which allows a suction effect on the chips generated during machining, and so that they can be extracted downwards as seen from the conveying path and fed to a collection container or similar.

In the embodiment in FIG. 2, the device also has two transport devices 11 arranged symmetrically to tool 31 and parallel to each other. As further shown, these are each received by means of a drive roller 12 and a deflection roller 13 and driven by a common motor 14. However, they could also be provided with separate drives. Furthermore, suction area 50 is preferably formed around tool 31 in order to maximize the suction power and thus the suction force with which the workpiece W is pressed onto the transport devices 11 during the machining of the workpiece W.

As can also be seen in FIG. 2, suction area 50 is preferably arranged between the two transport devices 11 and the tool 31 and has a plurality of suction holes 56 through which the vacuum acts on the workpiece W passing by. The distance between the respective suction holes 56 can be varied over the longitudinal direction of the suction area 50, which is parallel to the conveying direction X (in FIG. 2 from left to right) of the conveying device 10. For example, in the vicinity of tool 31, the distance between the suction holes 56 is preferably reduced (increasing the density of the suction holes), and in feed-in area 58 and feed-out area 59 of the conveying device 10, the distance is increased (not shown) away from tool 31.

As can also be seen in FIG. 1, extraction device 40 and suction area 50 are arranged flow-wise parallel to each other, i.e. the vacuum from vacuum device 80 is guided or conducted parallel to extraction device 40 and suction area 50. For this purpose, both can be connected to the vacuum device 80 via a common connection portion 53.

As previously described, conveying device 10 has a feed-in area 58 and a feed-out area 59. According to the two areas, the suction area can also be divided into a feed-in suction area and a feed-out suction area.

In the embodiment shown in FIG. 1, the device also has a hold-down device 90, with which the workpieces W can be held down if necessary and thus additionally pressed onto the transport devices 11 if necessary. If the additional pressure force is only required during the machining of the workpieces W, it may be sufficient to place the hold-down device 90 only above the area of the conveying device 10 where machining takes place.

The hold-down device 90 can be made, in particular as shown, in the form of an upside down mounted roller conveyor whose distance to the conveying device 10 and thus to the transported workpieces 10 is adjustable. Instead of the featured rollers 91, which are arranged consecutively in conveying direction X, belts, rails or the like can also be provided.

The transport devices 11 can be formed as chain or belt, preferably toothed belt, which is not shown in detail in the figures. If a toothed belt is used as transport devices 11, it should have a high coefficient of friction, especially in the area of the contact surface with the workpieces W. It is therefore advantageous if the contact surface of the toothed belt is made of natural rubber, silicone rubber or a corresponding material with a high coefficient of friction.

As is also clear from the embodiment shown in FIG. 1, the machining device 30 is designed as a cutting device 30, which has a saw blade 31. The saw blade 31 is mounted upright (vertically) and rotates about an axis of rotation that is perpendicular to the conveying direction X and parallel to a conveying plane spanned by the conveying device 10 (or the transport devices 11). Furthermore, the saw blade 31 projects slightly upwards over the transport devices 11 to ensure the workpieces W can also be parted. Due to the arrangement as described, the machining direction, i.e. the cutting direction of saw blade 31, is parallel to the conveying direction X of conveying device 10.

The following describes in more detail the exemplary base frame 70 of the apparatus for machining shown in FIG. 1. The base frame 70 serves to accommodate the conveying device 10, the machining device 30, the extraction device 40 and the suction area or areas 50. Preferably, base frame 70 is formed below the conveying device 10, in the form of a box housing 75. As FIG. 1 shows, the box housing 75 has three bulkhead walls.

Below the feed-in area 58, a feed-in bulkhead wall 71 is arranged, which together with a cover plate 74 of the extraction chamber 52 and outer walls 76 of the box housing 75 forms a feed-in extraction chamber 54. Furthermore, a feed-out bulkhead wall 73 is arranged below feed-out area 59 near tool 31 and extraction chamber 52. A rear bulkhead wall 72 is located at the other end of feed-out area 59, i.e. at the end of feed-out area 59 remote from tool 31. The feed-out bulkhead wall 73 and rear bulkhead wall 72 together with the outer walls 76 of box housing 75 and cover plate 74 of extraction chamber 52 form a feed-out extraction chamber 55. As shown in FIG. 1, the three bulkhead walls are arranged parallel to each other and perpendicular to conveying direction X. Furthermore, extraction chamber 52, feed-in extraction chamber 54 and feed-out extraction chamber 55 are open at the bottom, which means that three extraction chambers 52, 54, 55 communicate openly with each other. As also shown, the three extraction chambers 52, 54, 55 are connected to the vacuum device 80 using a common connection portion 53, which is provided on an outer wall 76 of box housing 75.

If vacuum device 80 is to be integrated directly into box housing 75, a similar design is conceivable. In this case, vacuum device 80 can be accommodated in a fourth chamber, which is arranged perpendicular to the three extraction chambers and can communicate with the three extraction chambers via a central passage.

In both cases it is advantageous if connection portion 53 or the passage is provided in the lower area of box housing 75, e.g. in an outer wall 76 of box housing 75. It is preferably that connection portion 53 is centred with respect to an outer wall 76 of box housing 75 parallel to conveying direction X.

As shown in the top view of the apparatus of FIG. 2 for machining workpieces according to an embodiment, suction area 50 or suction areas 58/59 are formed by cover plates 51 of box housing 75, which have a plurality of suction holes 56. Two symmetrical cover plates 51 are provided in the embodiment shown, each covering the complete suction area 50 to the right and left of the tool.

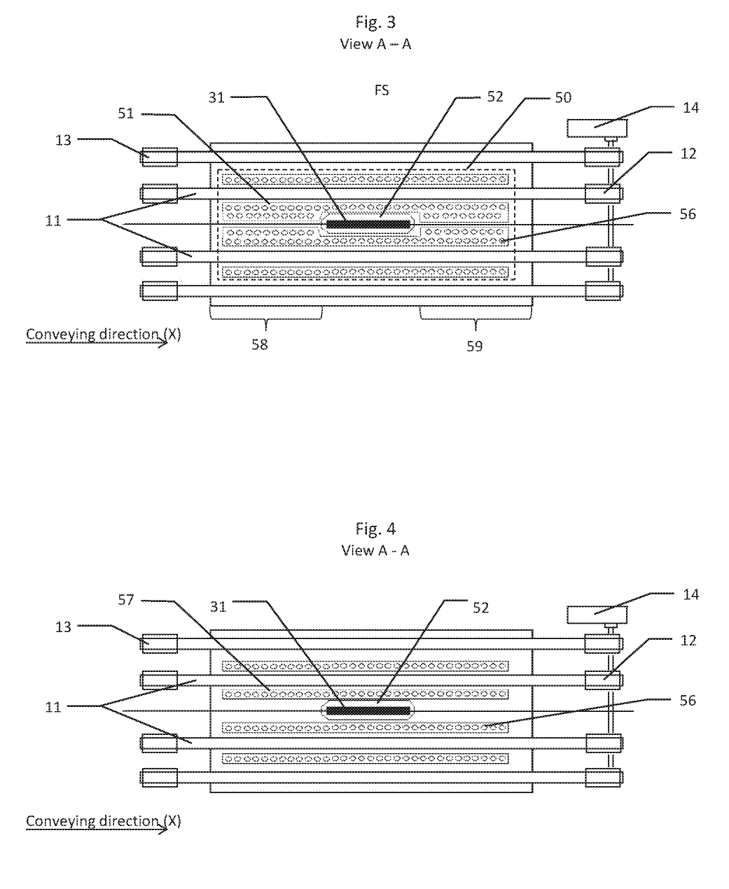

FIG. 3 shows another embodiment in which conveying device 10 has four transport devices 11, which are arranged parallel to each other and symmetrical to tool 31. According to the four transport devices 11, suction area 50 is formed by four cover plates 51, of which two cover plates 51 are arranged between tool 31 and the inner transport devices 11, and the other two cover plates 51 are arranged between inner and outer transport devices 11. By means of this arrangement of the cover plates 51, cover area 51 can be maximized, whereby the machined workpieces W are sucked in over a large area and thus pressed against transport devices 11 over a large area.

In the embodiment shown in FIG. 4, conveying device 10 is also constructed using four transport devices 11, which are arranged parallel to each other and symmetrical to tool 31. In contrast to the embodiment shown in FIG. 3, however, suction area 50 is not formed by means of four cover plates 51, but is formed by four self-contained suction boxes 57, which are preferably designed cost-effectively in the form of suction pipes with a rectangular cross-section. As with the design with cover plates 51, suction boxes 57 have a plurality of suction holes 56. The advantage of making suction area 50 using suction boxes 57 is that the suction boxes 57 themselves are airtight except for the suction holes 56 and the connection for vacuum device 80. This makes a complex, almost airtight seal of box housing 75 obsolete.

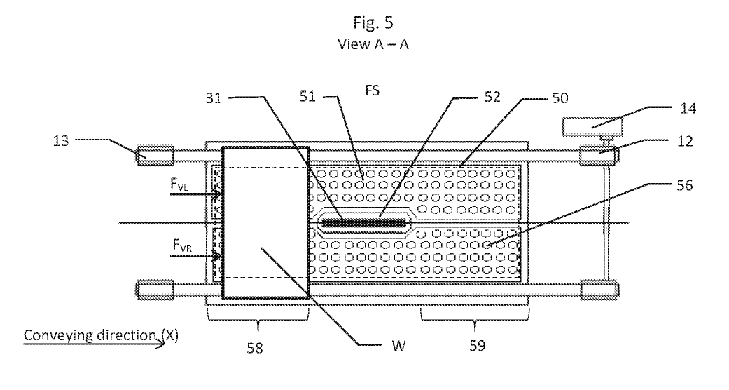

FIG. 5 serves to illustrate the feed forces already described above (F_{VL}, F_{VR}) which act on workpiece W due to the frictional connection in play between the transport devices and the workpiece. In FIG. 5, a workpiece W is shown, which is located in feed-in area 58, i.e. shortly before machining. As can be seen from FIG. 5, the plate-shaped workpiece W covers suction holes 56 of the feed-in suction area over a large area, whereby the vacuum can act on workpiece W and thus pressed it against transport devices 11 in addition to its own weight. By sucking in or pressing the workpiece against transport devices 11, a frictional connection can be generated, whereby in conjunction with the transport speed of the transport devices 11, one or more feed forces (F_{Vn}, F_{Vn}), in the embodiment shown two feed forces (F_{VL}, F_{VR}), act on the workpiece, which can be used as feed force during machining.

In summary, the apparatus according to the invention for machining workpieces W and their further developments creates a cost-effective device with which preferably plate-shaped workpieces W are pressed against transport device or devices 11 of a conveying device 10 included in the apparatus, by suction of the workpieces W, using a suction area 50 integrated in the apparatus, whereby it is made possible to transport the workpieces W safely and precisely in position with conveying device 10 during machining.

As a result, a complex holding and feeding device for positioning and holding the workpieces W during machining, in particular for providing the necessary feed force for machining, can be dispensed with. This greatly simplifies the design of the apparatus of the invention. In addition, the use of a common vacuum device 80 for suction area 50 and extraction device 40, which serves to extract chips produced during machining, can reduce the complexity of the apparatus and reduce the energy requirement by sparing the need for a further vacuum device 80. Furthermore, with the proposed apparatus, the known susceptibility to dirt of conventional conveying devices with suction function can be reduced and, in the case of a central extraction system, the associated high maintenance costs can be reduced or avoided by eliminating any dust filters or collection containers for the chips produced.

1. An apparatus for machining workpieces, preferably plate-shaped workpieces, wherein the workpieces consist in particular at least partly of wood, engineered wood, plastic, aluminium, sheet metal or a combination thereof, comprising:
a machining device, with a tool for machining the workpieces an extraction device for extracting chips produced during machining; a suction area for suctioning the workpieces during machining; and a vacuum interface area, in particular a connection portion, for a vacuum device, which vacuum interface area is connected to the extraction device and the suction area to supply the extraction area and suction area with vacuum.

2. The apparatus according to claim 1, wherein the apparatus further comprises a conveying device with a conveying path for conveying the workpieces, in particular horizontally, by means of at least one transport device,
wherein the machining device is arranged in the area of the conveying path, and wherein the suction area sucks the workpieces in the direction of the at least one transport device.

3. The apparatus according to claim 1, having the vacuum device, preferably with the vacuum device as an external suction system, in particular a central suction system, or a vacuum device integrated in the apparatus, preferably a vacuum pump.

4. The apparatus according to claim 2, wherein the extraction device has an extraction chamber which at least partially surrounds the tool and is arranged below the conveying path, whereby the chips produced are extracted downwards as seen from the conveying path.

5. The apparatus according to claim 2, wherein the conveying device has at least two transport devices running parallel to one another, which are each received by means of a drive roller and a deflection roller, and driven by at least one motor, the tool being provided between the at least two transport devices, preferably centrally, and the suction area preferably being formed around the tool.

6. The apparatus according to claim 2, wherein the suction area has a plurality of suction holes and is preferably arranged between the at least one transport device and the tool.

7. The apparatus according to claim 1, wherein the extraction device and the suction area are connected, flow-wise parallel to each other, to a vacuum device, in particular via a common vacuum interface area, in particular a connecting portion.

8. The apparatus according to claim 2, further comprising a hold-down device for holding down and, if necessary, additional pressing of the workpieces against the transport device(s), wherein the hold-down device preferably comprises several rollers arranged consecutively in the conveying direction, or is made of belts, rails or the like.

9. The apparatus according to claim 2, wherein the transport device(s) is/are designed as a chain or toothed belt, preferably toothed belt, which, in the area of the contact surface with the workpieces, consists of natural rubber, silicone rubber or a corresponding material with a high friction coefficient.

10. The apparatus according to claim 1, wherein the machining device is built as a cutting device with a saw blade.

11. The apparatus according to claim 2, further comprising a base frame for receiving the conveying device, the machining device, the extraction device and the suction area and/or suction areas , which base frame is formed below the conveying device in the form of a box housing which has a feed-in bulkhead wall, a feed-out bulkhead wall and a rear bulkhead wall,
wherein the feed-in bulkhead wall together with a cover plate of a/the extraction chamber and outer walls of the box housing form a feed-in suction chamber,
wherein the feed-out bulkhead wall together with the cover plate of the extraction chamber, the rear bulkhead wall and the outer walls of the box housing form a feed-out suction chamber, and
wherein the extraction chamber is open downwards into box housing, by which three openly communicating extraction chambers are formed, which can be supplied with a vacuum by way of the common vacuum interface area, in particular connection portion, which is provided on an outer wall of box housing.

12. The apparatus according to claim 11, wherein the vacuum interface area, in particular the connection portion, is circular and preferably provided in the lower area of an outer wall of box housing.

13. The apparatus according to claim 11, wherein feed-in bulkhead and feed-out bulkhead are housed in box housing such that they are each pivotable about an axis in such a way that the orientation of the two bulkheads relative to each other is variable, whereby the suction air ratio between the three extraction chambers can be varied.

14. The apparatus according to claim 1, wherein suction area or suction areas is/are formed by cover plates of box housing which have the plurality of suction holes, and/or suction area or suction areas is/are formed as a closed suction box(es), preferably as suction pipe(s).

15. A methodfor machining workpieces, preferably plate-shaped workpieces, in particular workpieces consisting at least partly of wood, engineered wood, plastic, aluminium, sheet metal or a combination thereof, comprising:
suction of the workpiece during machining, it being preferred that the workpiece is transported during machining;
machining of the workpiece; and
extraction of chips produced during machining,
wherein extraction of the chips and suction of the workpiece is carried out by a vacuum provided by a common vacuum interface area, in particular a connection portion.
